(19) United States
(12) Patent Application Publication
(10) Pub. No.: US 2009/0125389 A1
(43) Pub. Date: May 14, 2009

(54) System and Method for Opportunistically Distributing Promotional Objects

(75) Inventors: Gregory A. Dunko, Cary, NC (US); William O. Camp, JR., Chapel Hill, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/939,799

(22) Filed: Nov. 14, 2007

(51) Int. Cl. G06Q 30/00

(52) U.S. Cl. 705/14

(57) ABSTRACT

User devices are used to opportunistically distribute promotional objects for advertisers and producers. A promotional object is received by a user device from a source device, which may comprise a distribution system or another user device. The user device adds address information to the promotional object and stores the promotional object in memory. The user device may subsequently transfer the promotional object along with the address information to a target device, which may comprise another user device or a data collection system.

### BACKGROUND

The present invention relates generally to a system and method for opportunistically distributing promotional objects in an ad hoc network environment.

Mobile devices, such as mobile telephones, personal digital assistants, music players, video players, etc., have become prevalent in modern society. Virtually everyone carries at least one mobile device and some people routinely carry multiple mobile devices. Many mobile devices are equipped with short-range communication interfaces that enable the mobile devices to communicate with nearby mobile devices that are similarly equipped. The short-range interfaces allow mobile devices to form ad hoc networks and to share files with other mobile devices. For example, users of mobile devices can share music and video files, ring tones, photographs, and other data files.

It would be beneficial if the ability of mobile devices to form ad hoc networks and share files could be leveraged by businesses to advertise or promote their goods and services.

### SUMMARY

The present invention provides a method for opportunistically distributing promotional objects to consumers to advertise goods or services of a producer. A promotional object may comprise any type of digital object including a digital coupon, digital ticket, media file, software application, etc., that is used to promote the goods or services of a producer or advertiser. The digital object may be stored in memory of a user device, and passed from one user device to another to distribute the promotional object.

User devices that receive the promotional object add address information associated with the user device to the promotional object in order to create a distribution history. The distribution history is transmitted with the promotional object each time the promotional object is transferred. When the promotional object is used, the distribution history is transmitted to a data collection system. The distribution history enables the data collection system to determine the source of the promotional object and each previous “holder” of the promotional object. Previous holders of the promotional object may receive rewards or credits when subsequent holders of the promotional object activate or otherwise use the promotional object.

### BRIEF DESCRIPTION OF THE DRAWINGS

FIG. 1 illustrates an exemplary marketing system for distributing promotional objects.

FIG. 2 illustrates an exemplary method for transmitting promotional objects to user devices.

FIG. 3 illustrates an exemplary method for collecting distribution history data from user devices.

FIG. 4 illustrates another exemplary method for collecting distribution history data from user devices.

FIG. 5 illustrates an exemplary distribution system for distributing promotional objects.

FIG. 6 illustrates an exemplary data collection system for collecting distribution history data from user devices.

FIG. 7 illustrates an exemplary user device for distributing promotional objects.

### DETAILED DESCRIPTION

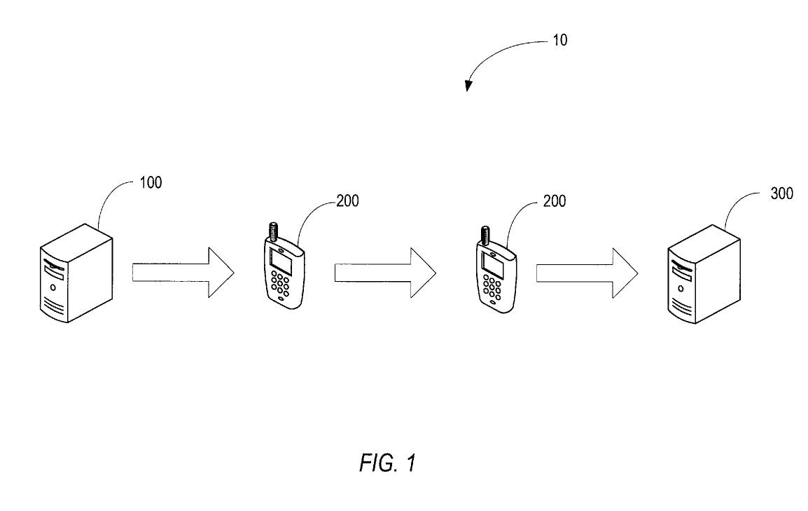

FIG. 1 illustrates the main components of a marketing system 10 for opportunistically distributing promotional objects according to one exemplary embodiment. The promotional objects may comprise digital coupons, tickets, media files, software applications, or other types of digital objects that are distributed to promote the goods or services of a producer or advertiser. Some promotional objects, such as a digital coupon, may entitle the holder to receive a benefit. Other promotional objects, such as a music file or video file, may be an object that can be played or otherwise used by a recipient of the promotional object.

The marketing system 10 comprises a distribution system 100, a plurality of user devices 200, and a data collection system 300. The distribution system 100 represents the point at which the promotional objects are introduced to consumers. The distribution system 100 stores promotional objects and transfers the promotional object to one or more user devices 200. The user devices 200 preferably comprise mobile devices, such as cellular telephones, personal digital assistants, laptop computers, etc. that are carried from place to place by users. The distribution system 100 and user devices 200 preferably include short-range interfaces that enable the user devices 200 to communicate with the distribution system 100. The user devices 200 may receive the promotional objects from the distribution system 100 via the short-range interface when the user device 200 comes within the range of the distribution system 100. User devices 200 may also receive promotional objects via the short-range interface from other user devices 200. In some embodiments, the promotional objects may be transmitted from the distribution system 100 over a network or direct link to the user devices 200. For example, promotional objects may distributed to user devices 200 through a web site. In other embodiments, users may download promotional objects to their home computers and subsequently transfer the promotional objects to their user devices 200 via a USB connection.

After receiving a promotional object from either the distribution system 100 or another user device 200, the user device 200 adds address information to the promotional object and stores the promotional object in memory. The address information may, for example, comprise a phone number, IP address, SIP address, or email address associated with the user device 200. The promotional object may include a header or wrapper to contain the address information. The user device 200 may subsequently transfer the promotional object to other user devices 200 while retaining a copy of promotional object in its own memory. It will be appreciated by those skilled in the art that the mobility of user devices 200 facilitates widespread distribution of the promotional object. Each user device 200 that receives the promotional object adds its own address information to create a distribution history for the promotional object. The distribution history records the path of the promotional object from any recipient back to the original user or source.

User devices 200 that receive the promotional object may, subject to any restrictions imposed by the issuer of the promotional object, activate or use the promotional object. The promotional object may comprise a digital coupon or ticket that may be exchanged for a benefit, such as a discount on goods or services or free admission to a show. As another example, the promotional object may comprise a music file, video file, or other object that can be rendered of used by the user device 200. When the promotional object is used, the distribution history associated with the promotional object is transferred directly or indirectly to a data collection system 300. Previous holders of the promotional object identified by the distribution history may receive a reward for participating in the distribution of the promotional object. A reward notification and/or a reward may be transmitted to the previous holders of the promotional object, whose addresses are known from the distribution history. The data collection system 300 could be co-located with the distribution system 100, or may comprise a separate system.

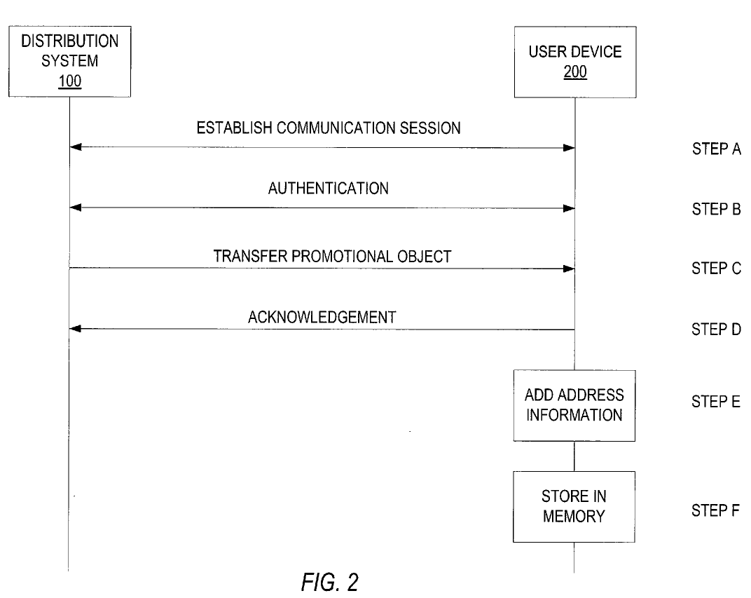

FIG. 2 illustrates an exemplary method for transferring promotional objects from a distribution system 100 to a user device 200 according to one exemplary embodiment. In this example, it is assumed that the distribution system 100 and user device 200 are both equipped with a short-range interfaces. The distribution system 100 may be located in a public place, such as a shopping mall or theater, where consumers are likely to be present. When the user device 200 comes within range of the distribution system 100, the user device 200 establishes communication with the distribution system 100 (step A). The distribution system 100 and user device 200 may optionally execute an authentication procedure to authenticate the user device 200 (step B). Authentication, however, is not required. Following the establishment of a communication link and authentication of the user device 200, the distribution system 100 transfers a promotional object to the user device 200 (step C). The user device 200 acknowledges the transfer (step D), adds address information to the promotional object (step E), and stores the promotional object in memory (step F). The promotional object may include a header or wrapper to contain the address information. In this case, the user device 200 adds its address information to the pre-existing header. In some embodiments, the first user device 200 receiving the promotional object may add the header or wrapper, and each subsequent user device 200 adds its address information to the same header. In other embodiments, each user device 200 may add a new header with its own address information to the promotional object.

The procedure shown in FIG. 2 may also be used to transfer the promotional object from one user device 200 to another user device 200. Those skilled in the art will appreciate that other methods can be used to transfer the promotional object to the user device 200. For example, the promotional object could be distributed through a web site on the Internet. Users may access the web site directly with the user device 200 to download the promotional object. Alternatively, users could download promotional objects to their personal computers and subsequently transfer the promotional objects to their user devices 200.

The promotional object stored in memory of the user device 200 may be activated and used by the user device 200. In some embodiments of the invention, the promotional object may be tendered to a third party to receive some benefit, such as a discount on goods or services, or free admission to a show. For example, the promotional object may comprise a digital coupon or ticket. In this case, the promotional object may be deleted or disabled after it is used. In other embodiments, the promotional object may comprise a music file, video file, or other object that may be played or otherwise used by the user device 200. In some embodiments of the invention, an activation code may be required in order to use the promotional object. When the promotional object is used, the promotional object and/or the distribution history is transmitted to the data collection system 300. The promotional object may contain restrictions on its use. For example, the promotional object may be a music file or video file that may be played only a predetermined number of times.

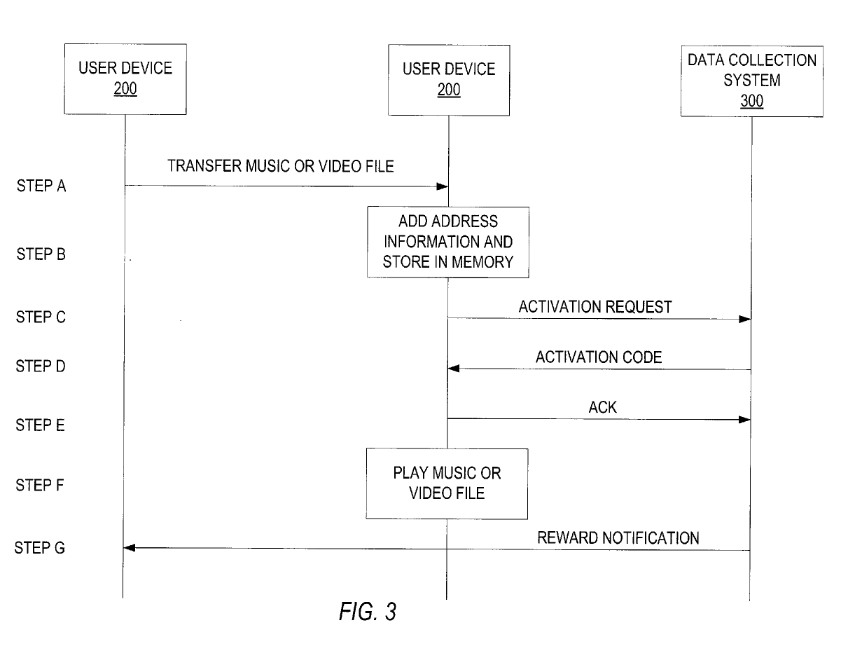

FIG. 3 illustrates an exemplary method for collecting distribution histories from user devices 200. In this example, it is assumed that the promotional object comprises a music file, video file, or similar object that can be played or otherwise used by the user device 200. The user device 200 receives the music file, from another user device 200 or from a distribution system 100 (step A). The user device 200 receiving the promotional object adds its address information to the promotional object and stores the promotional object in memory (step B). The music file may be “locked” to prevent its use without a valid activation code. When the user desires to play the music file, a user application in the user device 200 sends an activation request to a data collection system 300 (step C). The activation request includes an object identifier and the distribution history for the promotional object to the data collection system 300. In some embodiments, the distribution history may be sent in a separate message after the activation request is acknowledged by the data collection system 300. In response to the activation request, the data collection system 300 sends a valid activation code to the user device 200 (step D). The user device 200 acknowledges receipt of the activation code (step E) and may then play or otherwise use the promotional object (step F). When the object is played, the user application may be prompted to supply the activation code received from the data collection system 300 to “unlock” the promotional object. Upon receipt of the acknowledgement from the user device 200, the data collection system 300 may send a reward notification and/or reward to the previous holders of the promotional object, who are identified by the distribution history (step G).

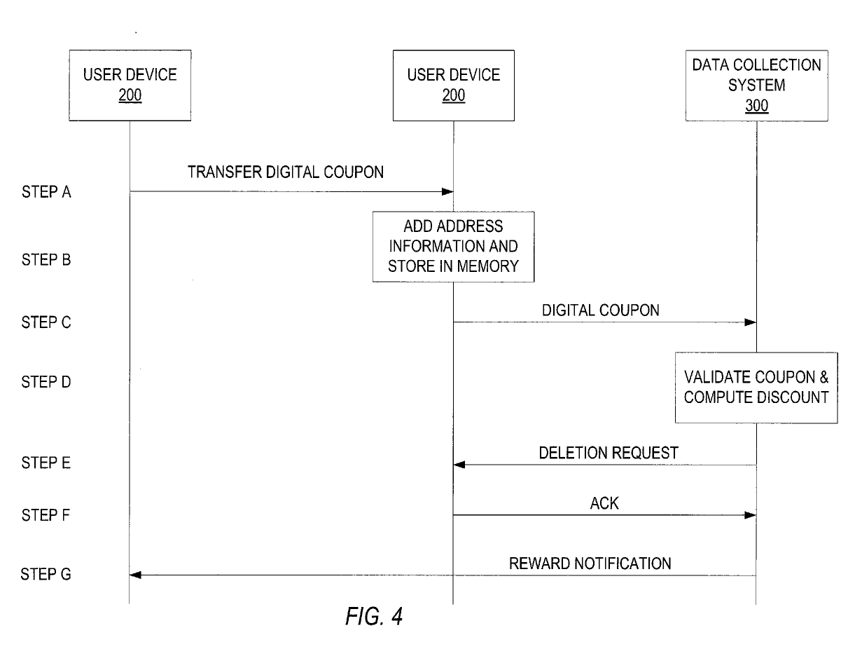

FIG. 4 illustrates another exemplary method for collecting distribution histories from user devices 200. In this example, it is assumed that the promotional object comprises a digital coupon, digital ticket, or similar promotional object that entitles the holder to receive a benefit, such as discount on goods or services or free admission to a show. In this example, the promotional object is not locked; however, those skilled in the art will appreciate that the promotional object could be locked if desired. The user device 200 receives the promotional object from another user device 200 or from a distribution system 100 (step A). The user device 200 receiving the promotional object adds address information to the promotional object and stores the promotional object in memory (step B). When the discount coupon or ticket is used, the user device 200 transfers the promotional object to a data collection system 300 maintained by the provider of the goods or services (step C). The data collection system 300 may, for example, be incorporated into a point-of-sale terminal of the provider. Upon validation of the promotional object, the user receives a discount for goods or services associated with the provider (step D). The object is then deleted from the memory of the user device 200 or otherwise rendered unusable (steps E and F). A reward notification and/or reward is sent to the previous holders of the promotional object (step G).

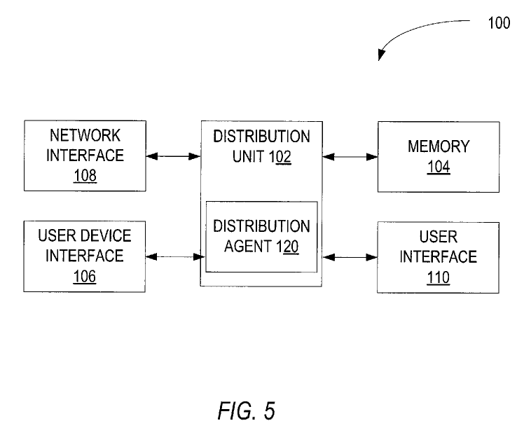

FIG. 5 illustrates an exemplary distribution system 100 configured in accordance with one or more embodiments of the present invention for distributing promotional objects. Distribution system 100 comprises a distribution control unit 102, data storage unit 104, user device interface 106, network interface 108, and optionally a user interface 110.

The distribution control unit 102 handles the distribution of promotional objects. The distribution control unit 102 may comprise one or more processors, microcontrollers, hardware circuits or a combination thereof. The main functions of the distribution control unit 102 may be implemented by a software application, referred to herein as the distribution agent 120. The distribution agent 120 communicates with user devices 200, handles the storage and retrieval of promotional objects, authenticates user devices 200, and transfers promotional objects to user devices 200. When a user device 200 comes within the range of the distribution system 100, the distribution agent 120 establishes communication with the user device 200 and transfers one or more promotional objects to the user device 200. The distribution agent 120 may also maintain records of the user devices 200 that have received the promotional object.

The data storage unit 104 may comprise a hard disk drive or other non-volatile memory unit configured to store a library of promotional objects. The data storage unit 104 may comprise, for example, optical or magnetic disk drives (e.g., hard disks). The optical or magnetic disk drives may be mounted in a disk drive array that may be expanded as needed depending on the amount of data to be stored. The optical and magnetic disk drives may be removable disk drives. The data storage unit 104 could also comprise a memory device, such as a read only memory, random access memory, or flash memory.

User device interface 106 comprises a short-range interface for communication with nearby user devices 200. Promotional objects are transferred to the user devices 200 via the user device interface 106. The user device interface 106 may comprise a Bluetooth transceiver and support the Bluetooth Service Discovery Profile and the Bluetooth File Transfer Profile. With these profiles, user devices 200 may be detected and a communication link with the user device 200 may be established by the distribution agent. The user device interface 106 may further comprise a near field communication (NFC) interface, which permits communication only at very short distances.

The distribution system 100 may further include a network interface 108 and user interface 110. The network interface 108 enables the distribution system 100 to communicate over a communication network with other devices. The network interface 108 may, for example, comprises an Ethernet interface, wireless LAN interface, modem, or cellular interface. In some embodiments, the network interface 108 may be used to transfer promotional objects to user devices 200. The user interface 110, if present, may include a display and one or more input devices, such as keypads, keyboards, pointing device, etc., to enable the operator to set up and maintain the distribution system 100.

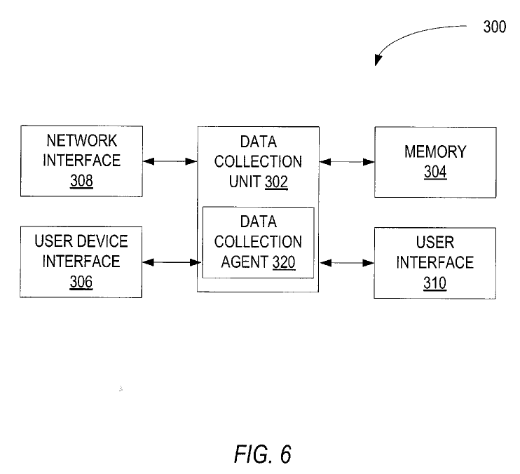

FIG. 6 illustrates an exemplary data collection system 300 configured in accordance with one or more embodiments of the present invention. Data collection system 300 comprises a data collection unit 302 to collect data related to the distribution history of promotional objects after the user devices 200 have activated or used a promotional object. The data collection unit 302 may comprise one or more processors, microcontrollers, hardware circuits or a combination thereof. The main functions of the data collection unit 302 may be implemented by an application referred to herein as the data collection agent 320. The data collection agent 320 communicates with user devices 200, collects distribution histories from the user devices 200, maintains a database for storing distribution histories, and provides activation codes to user devices 200 to activate promotional objects. The data collection agent 320 may also be responsible for processing the distributing data and providing rewards to user devices 200 involved in the distribution of promotional objects. Alternatively, the distribution history data may be sent to a separate processing center.

The distribution history data may be received by the data collection unit 300 via a user device interface 306, or a network interface 308. The network interface 308 may, for example, comprises an Ethernet interface, wireless LAN interface, modem, or cellular interface. In some embodiments, the network interface 308 may be used to transfer promotional objects to user devices 200. The user device interface 306 may comprise a short-range interface, e.g., a BLUETOOTH interface, or a near-field communication (NFC) interface.

The collected data may be stored in a data storage unit 304. Alternatively, the data collection unit 302 may process the data and store the processed data in the data storage unit 304. The collected and/or processed data may be transmitted to an advertiser, processing center, or other party via the network interface 308.

The data collection system 300 may optionally include a user interface 310. The user interface 310, if present, may include a display and one or more input devices, such as keypads, keyboards, pointing device, etc., to enable the operator to set up, operate, and maintain the data collection system 300.

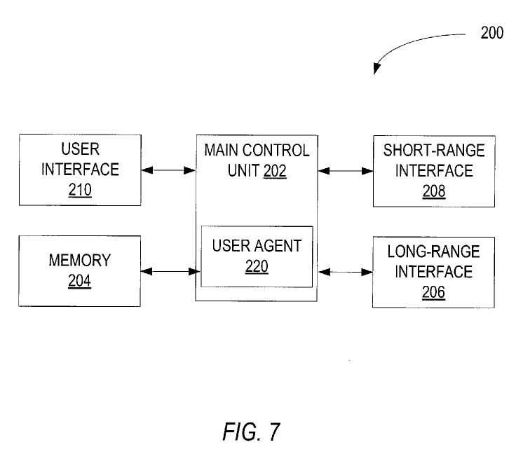

FIG. 7 illustrates an exemplary user device 200 for receiving, distributing, and using promotional objects. The user device 200 comprises a main control unit 202 to control the operation of the user device 200. Those skilled in the art will appreciate that the primary purpose of the user device 200 may be unrelated to the distribution of promotional objects. For example, the user device 200 may comprise a mobile telephone, personal digital assistant, laptop computer, etc. The main control unit 202 may comprise one or more microprocessors, microcontrollers, hardware circuits, and/or a combination thereof. The function of distributing and storing promotional objects may be implemented by a software application referred to herein as the user agent 220. The user agent 220 communicates with other devices 200 within the marketing system (e.g., the distribution system, 100, data collection system 300, and other user devices 200), and handles the transmission and storage of promotional objects as previously described.

Promotional objects received by the user device 200 are stored in memory 204. Memory 204 may comprise one or more memory devices, such as random access memory, read-only memory, and flash memory. Memory 204 may further comprise a data storage device, such as an optical disk, magnetic disk, or memory stick.

Long-range communication interface 206 connects the user device 200 to a communication network. The long-range communication interface 206 may comprise, for example, a cellular transceiver, WiFi transceiver, an Ethernet interface, cable modem, DSL interface, or other interface circuit. The long-range interface 206 may be used in some embodiments to receive the promotional objects from a distribution system 100, or to send the promotional object and/or distribution history to the data collection system 300.

The short-range communication interface 208 allows the user device 200 to communicate with similarly equipped devices over short distances. In the exemplary embodiments described herein, the user device 200 may use the short-range interface 208 to receive promotional objects from the distribution system 100 or other user devices 200, and to transmit the promotional object to other user devices 200 or to the data collection system 300. The short-range interface 208 may comprise a BLUETOOTH interface, or a near-field communication (NFC) interface.

The user interface 210 enables the user to interact with the user device 200. The user interface 210 may comprise, for example, a display for viewing information and one or more input devices, such a keypad, joystick, etc., for receiving user input.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method implemented by a user device equipped with a short-range interface for distributing a promotional object in a digital format, said method comprising:
receiving a promotional object from a source device;
storing a promotional object in memory of said user device;
adding address information associated with said user device to said promotional object; and
subsequently transferring said promotional object along with said address information to a target device.

2. The method of claim 1 wherein said address information comprises an address of said user device.

3. The method of claim 1 wherein said address information comprises one of a phone number, IP address, SIP address, and email address.

4. The method of claim 1 further comprising authenticating said source device prior to receiving said promotional object.

5. The method of claim 1 wherein adding said address information to said promotional object comprises adding said address information to a distribution history associated with said promotional object.

6. The method of claim 5 further comprising transmitting said distribution history to a data collection system when said promotional object is used.

7. The method of claim 1 wherein said promotional object comprises an object that entitles the holder to receive a benefit.

8. A user device comprising:
a short-range interface for receiving a promotional object in a digital format from a source device and for transmitting said promotional object to a target device;
memory for storing said promotional object; and
a processor operatively connected to said short-range interface and said memory, said processor configured to add address information associated with said user device to said promotional object, wherein said address information is transmitted to said target device along with said promotional object.

9. The user device of claim 8 wherein said address information comprises an address of said user device.

10. The user device of claim 8 wherein said address information comprises one of a phone number, IP address, SIP address, and email address.

11. The user device of claim 8 wherein said processor is configured to authenticate said source device prior to receiving said promotional object.

12. The user device of claim 8 wherein said promotional object includes a distribution history and wherein said processor adds said address information to said distribution history.

13. The user device of claim 12 wherein said processor is further configured to transmit said distribution history to a collection system when said promotional object is used.

14. The user device of claim 8 wherein said promotional object comprises an object that entitles the holder to receive a benefit.
